(19) United States
(12) Patent Application Publication
(10) Pub. No.: US 2008/0131750 A1
(43) Pub. Date: Jun. 5, 2008

(54) CERAMIC ELECTROLYTE STRUCTURE AND METHOD OF FORMING; AND RELATED ARTICLES

(75) Inventors: Todd-Michael Striker, Guilderland, NY (US); James Anthony Ruud, Delmar, NY (US); Stephane Renou, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC, Schenectady, NY (US)

(21) Appl. No.: 11/565,236

(22) Filed: Nov. 30, 2006

(51) Int. Cl. B05D 5/12; H01M 8/10

(52) U.S. Cl. 429/33; 429/30; 427/446; 427/453

(57) ABSTRACT

A ceramic electrolyte is provided. The ceramic electrolyte has a microstructure, which comprises at least a first region comprising a plurality of microcracks having a first average microcrack length and a first average microcrack width, and a second region comprising a second average microcrack length and a second average microcrack width. The microstructure satisfies the criteria of (a) the first average microcrack length being different from the second average microcrack length; or (b) the first average microcrack width being different from the second average microcrack width. A solid oxide fuel cell comprising a ceramic electrolyte having such a microstructure is provided. A method of making a ceramic electrolyte is also described. The method includes the steps of: providing a ceramic electrolyte comprising a plurality of nano-dimensional microcracks; and closing a number of the nano-dimensional microcracks preferentially from one surface of the ceramic electrolyte, such that the ceramic electrolyte has at least one hermetic region and one compliant region.

### BACKGROUND OF THE INVENTION

The invention is related to a ceramic electrolyte. More particularly, the invention is related to a ceramic electrolyte having at least one hermetic region and at least one compliant region. The invention is also related to a method of forming a ceramic electrolyte having at least one hermetic region and at least one compliant region.

Solid oxide fuel cells (SOFCs) are promising for producing electrical energy from fuel with high efficiency and low emissions. One barrier to the widespread commercial use of SOFCs is the high manufacturing cost. The manufacturing cost is largely driven by the need for state-of-the-art ceramic anodes, cathodes, or electrolytes, which allow the fuel cells to operate at high temperatures (e.g., about 800° C.). Fuel cell components, which can meet these criteria, require materials of construction that can be expensive to manufacture. Solid oxide fuel cells need to have high power densities and fuel utilizations, and large cells, to make the technology economically feasible.

Thermal spray processes, such as air plasma spray, have the potential to provide large area cells on interconnect supports that may reduce manufacturing costs. However, air-plasma-sprayed coatings typically contain both pores and microcracks, which in the case of a ceramic electrolyte may provide leak paths for the fuel and air. Microcracks are typically formed at interlamellar splat boundaries during deposition, or are formed through the thickness of the coating, due to large thermal expansion strains caused during the operation of the device. Such defects may limit the open cell voltage and fuel utilization. Therefore, there is a continuous need to improve the performance of a ceramic electrolyte by decreasing its defects, and by making it compliant with other layers in a device.

### BRIEF DESCRIPTION OF THE INVENTION

The present invention meets these and other needs by providing a ceramic electrolyte having at least one hermetic region and at least one compliant region. The hermetic region with relatively smaller microcracks and lower porosity provides hermeticity, and the compliant region with relatively larger microcracks and higher porosity provides compliance.

One embodiment of the invention is a ceramic electrolyte. The ceramic electrolyte has a microstructure, which comprises at least a first region comprising a plurality of microcracks having a first average microcrack length and a first average microcrack width; and a second region comprising a second average microcrack length and a second average microcrack width. The microstructure satisfies at least one of the following criteria: (a) the first average microcrack length is different from the second average microcrack length; or (b) the first average microcrack width is different from the second average microcrack width.

Another embodiment is a solid oxide fuel cell. The solid oxide fuel cell comprises an anode; a cathode; and a ceramic electrolyte disposed between the anode and the cathode. The ceramic electrolyte has a microstructure, which comprises at least a first region comprising a plurality of microcracks having a first average microcrack length and a first average microcrack width; and a second region comprising a second average microcrack length and a second average microcrack width. The microstructure satisfies at least one of following criteria (a): the first average microcrack length is different from the second average microcrack length; or (b) the first average microcrack width is different from the second average microcrack width.

In another embodiment, the invention provides a method of forming a ceramic electrolyte. The ceramic electrolyte has at least one hermetic region and at least one compliant region. The method comprises the steps of: providing a ceramic electrolyte comprising a plurality of nano-dimensional microcracks; and closing a number of the nano-dimensional microcracks preferentially from one surface of the ceramic electrolyte, such that the ceramic electrolyte has at least one hermetic region and at least one compliant region.

These and other features, aspects, and advantages of the present invention will become better understood when the following detailed description is read with reference to the accompanying drawings in which like characters represent like parts throughout the drawing.

### DESCRIPTION OF THE DRAWINGS

FIG. 1 is a cross sectional scanning electron micrograph of a sample air plasma sprayed yttria-stabilized zirconia ceramic electrolyte having nano-dimensional microcracks and pores;

FIG. 2 is a schematic view of a solid oxide fuel cell comprising a ceramic electrolyte, according to one embodiment of the invention;

FIG. 3 illustrates an enlarged portion of an exemplary fuel cell assembly, showing the operation of the fuel cell;

FIG. 4 is flow chart of a method, according to one embodiment of the invention, for preparing a ceramic electrolyte having at least one hermetic region and at least one compliant region;

FIG. 5 is flow chart of a method, according to one embodiment of the invention, for preparing a ceramic electrolyte with a graded microcrack density;

FIG. 6 is a cross sectional scanning electron micrograph of a sample processed yttria-stabilized zirconia ceramic electrolyte having at least one hermetic region and at least one compliant region;

FIG. 7 is a plot showing the change in permeability after each coating and heat treatment, for a sample air plasma sprayed yttria-stabilized ceramic electrolyte; and

FIG. 8 is a plot showing the results of a pressure decay test with air after each coating and heat treatment, for a sample air plasma sprayed yttria-stabilized ceramic electrolyte.

### DETAILED DESCRIPTION OF THE INVENTION

In the following description, like reference characters designate like or corresponding parts throughout the several views shown in the figures. It is also understood that terms such as “top,” “bottom,” “outward,” “inward,” “first,” “second,” and the like are words of convenience and are not to be construed as limiting terms. Furthermore, whenever a particular aspect of the invention is said to comprise or consist of at least one of a number of elements of a group and combinations thereof, it is understood that the aspect may comprise or consist of any of the elements of the group, either individually or in combination with any of the other elements of that group.

As used herein, “a nano-dimensional microcrack” is meant to describe a microcrack with at least one of the dimensions (length, width, or breadth) in the nanometer range. In the following embodiments, nano-dimensional microcracks typically have an average width less than about 200 nanometers, and an average length less than about 2000 nanometers. For purpose of understanding this invention, a “compliant region” is meant to describe a region with an elastic modulus that is substantially reduced from the elastic modulus of a fully dense body, by the inclusion of pores and microcracks. In the following embodiments, the compliant region is indicated by the presence of a substantial crack density. The relationship between crack density and modulus is well-known. [For example, see I. Sevostianov, M. Kachanov, J. Ruud, P. Lorraine, and M. Dubois, “Quantitative characterization of microstructures of plasma-sprayed coatings and their conductive and elastic properties,” Mat. Sci. Engg. A, v386, 164-174 (2004)]. As used herein a “hermetic region” is meant to describe a region that substantially restricts the flow of gas, as demonstrated by having a low gas permeability. In the following embodiments hermetic regions typically have an air permeability less than about 1×10⁻¹⁰ cm²Pa⁻¹ sec⁻¹.

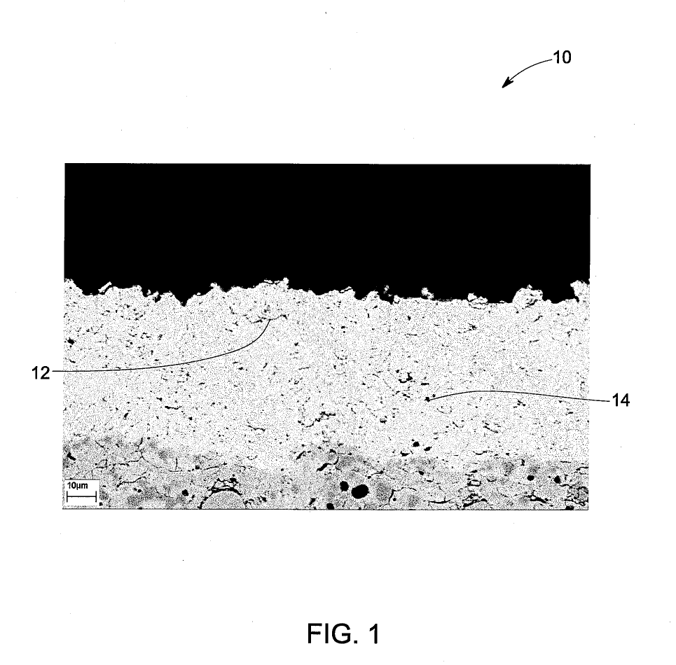

FIG. 1 shows a cross sectional scanning electron micrograph of a sample ceramic electrolyte 10 formed by a deposition technique, such as air plasma deposition, in one embodiment of the invention. The micrograph shows a plurality of features, such as nano-dimensional microcracks 12 and pores 14 formed during the deposition process. Additionally, in many device structures, ceramic electrolytes are stacked between ceramic and metal layers of different compositions having different thermal expansions. For example, in a solid oxide fuel cell, a ceramic electrolyte may be stacked between a cathode layer and an anode layer. During the operation of the device, due to repetitive thermal cycling and different thermal expansion of various layers, the ceramic electrolytes experience substantially high thermal strains. Large thermal expansion strains may cause additional microcracks through the thickness of the ceramic electrolyte. Such microcracks may impair the hermeticity of the layer. Therefore, it is desirable to develop a ceramic electrolyte that is compliant to reduce the tendency to form microcracks when incorporated in a device. The inventors have discovered that by providing a ceramic electrolyte having at least one compliant region and at least one hermetic region, it is possible to maintain hermeticity and also achieve compliance. Disclosed herein is also a versatile method to fabricate a ceramic electrolyte with such a microstructure.

One embodiment of the invention is a ceramic electrolyte. The ceramic electrolyte has a microstructure, which comprises at least a first region (a “hermetic region”), comprising a plurality of microcracks having a first average microcrack length and a first average microcrack width; and a second region (a “compliant region”), comprising a second average microcrack length and a second average microcrack width. Typically, the dimensions of the microcracks in the first and the second regions are different. Microcracks may have length, width, or both dimensions different in the two regions. The microstructure satisfies the criteria that (a) the first average microcrack length is different from the second average microcrack length; or (b) the first average microcrack width is different from the second average microcrack width; or both (a) and (b).

In these embodiments, the ceramic electrolyte is in the form of a monolithic structure. A “monolithic structure” as used herein, means a three-dimensional body portion constituting a single unit without a joint. This is in contrast to a body formed of multiple components, such as a laminated structure, or a multi-layered structure. A monolithic structure, for some embodiments of the invention, is characterized by different microcrack dimensions in different regions, and may provide many advantages, including ease of fabrication. Another advantage is that a monolithic structure that does not have an inherent interface is expected to be free from delamination problems. Delamination may lower the electrolyte ionic conductivity.

As known in the art, microcrack dimensions represent an important parameter that controls the elastic and thermal properties of a ceramic layer. The inventors have discovered that by providing different microcrack dimensions in different regions, it is possible to vary the elastic modulus within the monolithic electrolyte layer. Accordingly, a ceramic electrolyte having regions with substantially different elastic moduli is provided. This is achieved by tuning the microcrack density parameter in the different regions. The microcrack density parameter Γ, in a region of area A with N cracks of length lᵢ, is obtained from the following relationship:

$$Γ = \frac{{\sum }_{i = 1}^{N} {l}_{i}^{2}}{A} \qquad 1 )$$

Typically the second region (compliant region) has relatively larger microcracks than the first region (hermetic region). In one embodiment, the second average microcrack length is larger than the first average microcrack length. In a particular embodiment, the second average microcrack length is at least about 10% larger than the first average microcrack length. In another embodiment, the second average microcrack length is at least about 15% larger than the first average microcrack length. In one embodiment, the first average microcrack length is in a range from about 850 nanometers to about 900 nanometers, and the second average microcrack length is in a range from about 950 nanometers to about 1050 nanometers.

In certain embodiments, the second average microcrack width is larger than the first average microcrack width. In one embodiment, the second average microcrack width is at least about 5% larger than the first average microcrack width. In another embodiment, the second average microcrack width is at least about 10% larger than the first average microcrack width. In one embodiment, the first average microcrack width is in a range from about 95 nanometers to about 105 nanometers, and the second average microcrack width is in a range from about 105 nanometers to about 120 nanometers.

Furthermore, the porosity of the ceramic electrolyte in the first region (hermetic region) may differ from the porosity of the second region (compliant region). The microstructure comprises a first porosity in the first region and a second, different porosity in the second region. Typically, the second porosity is larger than the first porosity. In one embodiment, the second porosity is at least about 10% larger than the first porosity. In another embodiment, the second porosity is at least about 20% larger than the first porosity. In yet another embodiment, the second porosity is at least about 30% larger than the first porosity. In one embodiment, the first porosity has a value in a range from about 4.5 volume percent to about 6.5 volume percent, and the second porosity has a value in a range from about 6.5 volume percent to about 10 volume percent.

In certain embodiments, the hermetic region, comprising relatively smaller microcracks and lower porosity, is disposed at a top surface of the coated electrolyte; and the compliant region, comprising relatively larger microcracks and larger porosity, is disposed at a bottom surface of the electrolyte. In one embodiment, the first region (hermetic region) comprises a region from a top surface of the ceramic electrolyte to about 45% of the depth of the ceramic electrolyte, and the second region (compliant region) comprises a region from a bottom surface of the ceramic electrolyte, upwards, to about 45% of the depth of the ceramic electrolyte. In another embodiment, the first region (hermetic region) comprises a region from a top surface of the ceramic electrolyte to about 35% of the depth of the ceramic electrolyte, and the second region (compliant region) comprises a region from a bottom surface of the ceramic electrolyte, upwards, to about 35% of the depth of the ceramic electrolyte. The compliant region is towards the anode-side or the cathode-side of the electrolyte depending on the fuel cell configuration.

This difference in microcrack dimensions in the hermetic regions, as compared to the compliant regions, may lead to difference in the elastic moduli of the ceramic electrolyte. A microcrack in a ceramic material may function to relieve thermally induced stresses. Therefore, a ceramic with relatively large microcracks is more compliant and is more resistant to microcrack formation. However, the presence of microcracks can sometimes result in fuel and gas leakage. Therefore, a ceramic electrolyte having a small portion of relatively small microcracks providing hermeticity, and the other portion having relatively large microcracks providing compliance, would be advantageous.

The composition of the ceramic electrolyte, in part, depends on the end-use application. When the ceramic electrolyte is used in a solid oxide fuel cell, or an oxygen- or synthesis gas generator, the electrolyte may be composed of a material capable of conducting ionic species (such as oxygen ions or hydrogen ions), yet may have low electronic conductivity. When the ceramic electrolyte is used in a gas separation device, the ceramic electrolyte may be composed of a mixed ionic electronic conducting material. In all the above embodiments, the electrolyte may be desirably gas-tight to electrochemical reactants.

In general, for solid oxide fuel cell applications, the ceramic electrolyte has an ionic conductivity of at least about 10⁻³ S/cm at the operating temperature of the device, and also has sufficiently low electronic conductivity. Examples of suitable ceramic materials include, but are not limited to, various forms of zirconia, ceria, hafnia, bismuth oxide, lanthanum gallate, thoria, and various combinations of these ceramics. In certain embodiments, the ceramic electrolyte comprises a material selected from the group consisting of yttria-stabilized zirconia, rare-earth-oxide-stabilized zirconia, scandia-stabilized zirconia, rare-earth doped ceria, alkaline-earth doped ceria, rare-earth oxide stabilized bismuth oxide, and various combinations of these compounds. In an exemplary embodiment, the ceramic electrolyte comprises yttria-stabilized zirconia. Doped zirconia is attractive as it exhibits substantially pure ionic conductivity over a wide range of oxygen partial pressure levels. In one embodiment, the ceramic electrolyte comprises a thermally sprayed yttria-stabilized zirconia. One skilled in the art would know how to choose an appropriate electrolyte, based on the requirements discussed herein.

In the case of an electrolytic oxygen separation device, oxygen is driven across the membrane by applying a potential difference and supplying energy. In such embodiments, the ceramic electrolyte may be chosen from electrolytes well known in the art, such as yttria-stabilized zirconia (e.g., (ZrO₂)_{0.92}(Y₂O₃)_{0.08}, YSZ), scandia-stabilized zirconia (SSZ), doped ceria such as (CeO₂)_{0.8}(Gd₂O₃)_{0.2}(CGO), doped lanthanum gallate such as La_{0.8}Sr_{0.2}Ga_{0.85}Mg_{0.15}O_{2.285}(LSGM20-15), and doped bismuth oxide such as (Bi₂O₃)_{0.75}(Y₂O₃)_{0.25}, and the like.

In the case of a gas separation device, where partial pressures, rather than applied potential, are used to move ions across the electrolyte, the electrolyte may be a mixed ionic electronic conductor (MIEC). Examples of mixed ionic electronic conductor are La₁₋ₓSrₓCoO_{3-δ};(1≧x≧0.10)(LSC), SrCO₁₋ₓFeₓO_{3-δ}; (0.3≧x≧0.20), La_{0.6}Sr_{0.4}Co_{0.6}Fe_{0.4}O_{3δ}; LaNi_{0.6}Fe_{0.4}O₃, and Sm_{0.5}Sr_{0.5}CoO₃.

In some preferred embodiments, the ceramic electrolyte should be as thin as possible, in order to minimize resistive losses, but thick enough to ensure that it has no connected porosity. Connected porosity would generally allow fuel and oxidant gases to pass through, and may degrade the performance of the device. The ceramic electrolyte typically has a thickness in the range from about 5 micrometers to about 70 micrometers. In another embodiment, the ceramic electrolyte has a thickness in the range from about 20 micrometers to about 50 micrometers. Thermal deposition techniques such as air plasma spray deposition advantageously permit the deposition of electrolyte layers of any desired thickness. One skilled in the art would know how to optimize the thickness, depending on the device structure and operation conditions.

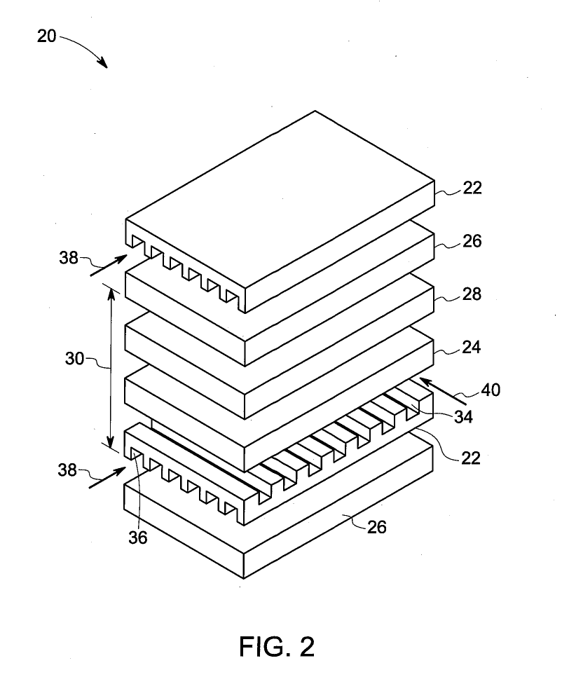

Another embodiment of the invention is a solid oxide fuel cell (SOFC). A fuel cell is an energy conversion device that produces electricity by electrochemically combining a fuel and an oxidant across an ionic conducting layer. As shown in FIG. 2, an exemplary planar fuel cell 20 comprises an interconnect portion 22, a pair of electrodes—a cathode 24 and an anode 26, separated by a ceramic electrolyte 28. In general, this cell arrangement is well-known in the art, although the configuration depicted in the figure may be modified, e.g., with the anode layer above the electrolyte, and the cathode layer below the electrolyte. Those skilled in the art understand that fuel cells may operate horizontally, vertically, or in any orientation.

The interconnect portion 22 defines a plurality of airflow channels 34 in intimate contact with the cathode 24, and a plurality of fuel flow channels 36 in intimate contact with the anode 26 of an adjacent cell repeat unit 30, or vice versa. In operation, a fuel flow 38 is supplied to the fuel flow channels 36. An airflow 40, typically heated air, is supplied to the airflow channels 34. The interconnect portion 22 may be constructed in a variety of designs, and with a variety of materials. Typically, the interconnect is made of a good electrical conductor such as a metal or a metal alloy. The interconnect desirably provides optimized contact area with the electrodes.

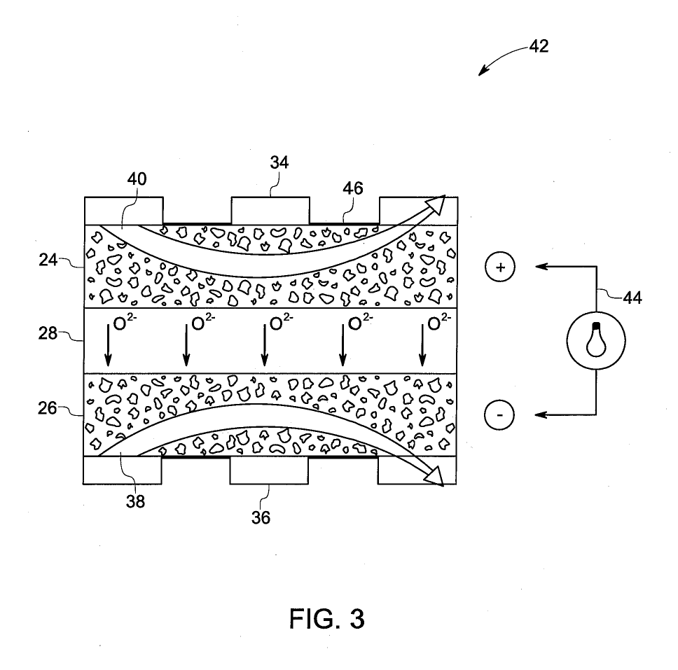

FIG. 3 shows a portion of the fuel cell illustrating its operation. The fuel flow 38, for example natural gas, is fed to the anode 26, and undergoes an oxidation reaction. The fuel at the anode reacts with oxygen ions (O²⁻) transported to the anode across the electrolyte. The oxygen ions (O²⁻) are de-ionized to release electrons to an external electric circuit 44. The airflow 40 is fed to the cathode 24. As the cathode accepts electrons from the external electric circuit 44, a reduction reaction occurs. The electrolyte 28 conducts ions between the anode 26 and the cathode 24. The electron flow produces direct current electricity, and the process produces certain exhaust gases and heat.

In the exemplary embodiment shown in FIG. 2, the fuel cell assembly 20 comprises a plurality of repeating units 30, having a planar configuration. Multiple cells of this type may be provided in a single structure. The structure may be referred to as a “stack”, an “assembly”, or a collection of cells capable of producing a single voltage output.

The main purpose of the anode layer 26 is to provide reaction sites for the electrochemical oxidation of a fuel introduced into the fuel cell. In addition, the anode material is desirably stable in the fuel-reducing environment, and has adequate electronic conductivity, surface area and catalytic activity for the fuel gas reaction under operating conditions. The anode material desirably has sufficient porosity to allow gas transport to the reaction sites. The anode layer 26 may be made of any material having these properties, including but not limited to, noble metals, transition metals, cermets, ceramics and combinations thereof. More specifically the anode layer 26 may be made of various materials. Non-limiting examples include nickel, nickel alloy, cobalt, Ni-YSZ cermet, Cu-YSZ cermet, Ni-Ceria cermet, or combinations thereof. In certain embodiments, the anode layer comprises a composite of more than one material.

The cathode layer 24 is typically disposed over electrolyte 28. The main purpose of the cathode layer 24 is to provide reaction sites for the electrochemical reduction of the oxidant. Accordingly, the cathode layer 24 is desirably stable in the oxidizing environment, has sufficient electronic and ionic conductivity, has a surface area and catalytic activity for the oxidant gas reaction at the fuel cell operating conditions, and has sufficient porosity to allow gas transport to the reaction sites. The cathode layer 24 may be made of any materials meeting these properties, including, but not limited to, an electrically conductive, catalytic oxide such as, strontium doped LaMnO₃, strontium doped PrMnO₃, strontium doped lanthanum ferrites, strontium doped lanthanum cobaltites, strontium doped lanthanum cobaltite ferrites, strontium ferrite, SrFeCo_{0.5}Oₓ, SrCo_{0.8}Fe_{0.2}O_{3-δ}; La_{0.8}Sr_{0.2} Co_{0.8}Ni_{0.2}O_{3-δ}; and La_{0.7}Sr_{0.3}Fe_{0.8}Ni_{0.2}O_{3-δ}, and combinations thereof. A composite of such an electronically conductive, catalytically active material and an ionic conductor may be used. In certain embodiments, the ionic conductor comprises a material selected from the group consisting of yttria-stabilized zirconia, rare-earth-oxide-stabilized zirconia, scandia-stabilized zirconia, rare-earth doped ceria, alkaline-earth doped ceria, rare-earth oxide stabilized bismuth oxide, and various combinations of these compounds.

Typically, the electrolyte layer 28 is disposed between the cathode layer 24 and the anode layer 26. The main purpose of the electrolyte layer 28 is to conduct ions between the anode layer 26 and the cathode layer 24. The electrolyte carries ions produced at one electrode to the other electrode to balance the charge from the electron flow, and to complete the electrical circuit in the fuel cell. Additionally, the electrolyte separates the fuel from the oxidant in the fuel cell. Typically, the electrolyte 28 is substantially electrically insulating. Accordingly, the electrolyte 28 is desirably stable in both the reducing and oxidizing environments, impermeable to the reacting gases, adequately conductive at the operating conditions, and compliant with the adjacent anode 26 and cathode 24. The ceramic electrolyte described for embodiments of the present invention has substantially high compliance, and superior gas-tight characteristics. These features provide distinct advantages over conventional ceramic electrolytes.

In some embodiments of the present invention, the ceramic electrolyte has a microstructure comprising at least one hermetic region and at least one compliant region, as described in detail in the above embodiments. As discussed above, the first region—termed a hermetic region—comprises a plurality of microcracks having a first average microcrack length and a first average microcrack width; and a second region—termed a compliant region—comprises a second average microcrack length and a second average microcrack width. Typically, the dimensions of the microcracks in the first and the second regions are different, as described previously. In one embodiment (FIG. 2), the ceramic electrolyte 28 is disposed between the cathode layer 24 and the anode layer 26 in such a way that the electrolyte has the compliant region closest to anode layer 26, and the hermetic region closest to cathode layer 24. In an alternative embodiment, the electrolyte has the compliant region closest to cathode 24, and the hermetic region closest to anode 26. In another embodiment, the ceramic electrolyte may have more than one compliant and hermetic region. The ceramic electrolyte may have any suitable composition, microcrack gradation, and thicknesses, including those listed in the embodiments discussed previously.

The anode, cathode, and electrolyte layers are illustrated as single layers for purposes of simplicity of explanation. It should be understood, however, that the anode layer may have a plurality of layers in which the particle size is graded. The composition of the material may also be graded for thermal compatibility purposes. In another example, the electrolyte structure may be used for a tubular geometry. Furthermore, though the operation of the cell is explained with a simple schematic, embodiments of the present invention are not limited to this particular simple design. Various, other designs—some of them complex—are also applicable, as will be appreciated by those skilled in the art. For example, in certain embodiments, the fuel cell may comprise a composite electrode-electrolyte structure, rather than individual electrode (anode/cathode) and electrolyte layers. Such composite structures may also be incorporated with electrocatalytic materials such as such as La₁₋ₓSrₓMnO₃(LSM), La₁₋ₓSrₓCoO₃(LSC), La₁₋ₓSrₓFeO₃(LSF), SrFeCo_{0.5}Oₓ, SrCo_{0.8}Fe_{0.2}O_{3-δ}; La_{0.8}Sr_{0.2}Co_{0.8}Ni_{0.2}O_{3-δ}; and La_{0.7}Sr_{0.3}Fe_{0.8}Ni_{0.2}O_{3-δ}, to enhance their performance. The fuel cell may comprise additional layers, such as buffer layers, support layers, and the like, helping to better match the coefficient of thermal expansion (CTE) of the layers. These layers may be in various forms, and may be prepared by various known techniques. As one example, the buffer/support layers may be a porous foam or tape, or in the form of a knitted wire structure.

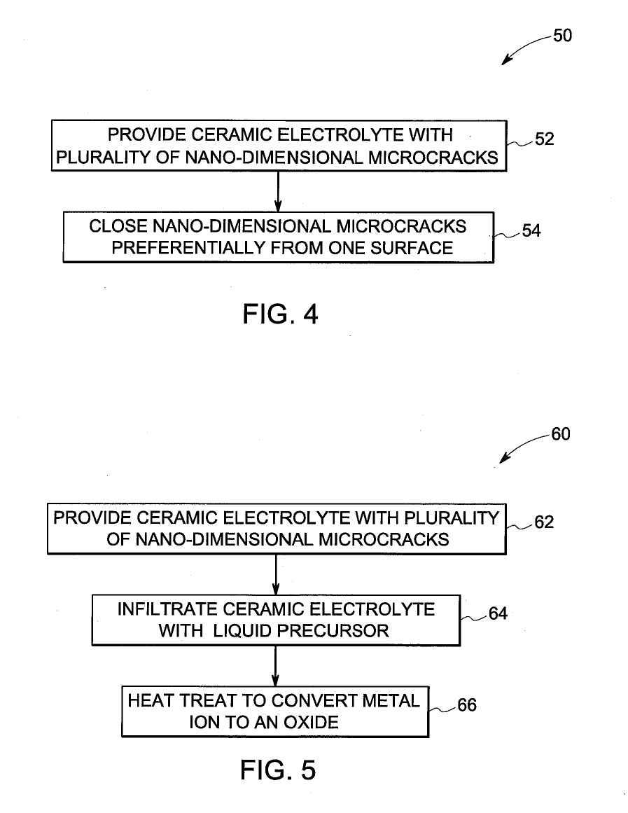

Another embodiment of the invention is a method of making a ceramic electrolyte having at least one compliant region and at least one hermetic region. FIG. 4 shows a flow chart of a process 50 to form a ceramic electrolyte, having at least one compliant region and at least one hermetic region. The method comprises the steps of: providing a ceramic electrolyte comprising a plurality of nano-dimensional microcracks in step 52; and closing a number of the nano-dimensional microcracks preferentially from one surface of the ceramic electrolyte in step 54. The preferential closing of pores is controlled such that the processed ceramic electrolyte has at least one hermetic region and at least one compliant region.

To start with, a ceramic electrolyte comprising a plurality of nano-dimensional microcracks is provided in step 52. A ceramic electrolyte layer may be fabricated by any known process in the art, e.g., by thermal deposition techniques. Examples of suitable thermal deposition techniques include, but are not limited to, plasma spraying, flame spraying, and detonation coating. Alternatively, the ceramic electrolyte layer may be deposited from a vapor phase such as pulse vapor deposition (PVD), electron beam pulse vapor deposition (EBPVD), or chemical vapor deposition (CVD). The ceramic layer may also be prepared by band casting or screen-printing of a slurry, followed by subsequent sintering. Layers manufactured with such processes often contain capillary spaces which are formed by pores and open microcrack structures, and which impair an intended function of the layer.

In an exemplary embodiment, the ceramic electrolyte layer is deposited by an air plasma spray (APS) process. Plasma spray coatings are formed by heating a gas-propelled spray of a powdered metal oxide or a non-oxide material with a plasma spray torch. The spray is heated to a temperature at which the powder particles become molten. The spray of the molten particles is directed against a substrate surface, where they solidify upon impact to create the coating. The conventional as-deposited APS microstructure is typically characterized by a plurality of overlapping splats of material, wherein the inter-splat boundaries may be tightly joined, or may be separated by gaps resulting in some pores and microcracks. The ceramic electrolyte may be applied by an APS process using equipment and processes known in the art. Those skilled in the art understand that the process parameters may be modified, depending on various factors, such as the composition of the electrolyte material, and the desired microstructure and thickness. Typically, the ceramic electrolyte comprising a plurality of nano-dimensional microcracks has a porosity less than 10%. The as deposited ceramic electrolyte is characterized by a gas permeability, measured in air, of less than about 8×10⁻¹⁰ cm²Pa⁻¹ sec⁻¹.

After depositing the electrolyte layer, a selected number of nano-dimensional microcracks are closed preferentially from one surface of the electrolyte layer, such that the ceramic electrolyte has at least one hermetic region and at least one compliant region.

A flow chart for an exemplary process 60 for forming a ceramic electrolyte having at least one hermetic region and at least one compliant region is shown in FIG. 5. The method comprises the steps of providing a ceramic electrolyte layer with a plurality of nano-dimensional microcracks in step 62. A selected number of nano-dimensional microcracks may then be closed, by infiltrating the ceramic electrolyte with a liquid precursor, as shown in step 64. The precursor may comprise at least one oxidizable metal ion. The ceramic electrolyte may then be heated to a temperature sufficient to convert the oxidizable metal ion to an oxide, thereby closing a selected number of nano-dimensional microcracks in step 66.

The ceramic electrolyte is infiltrated with a liquid precursor comprising at least one oxidizable metal ion in step 64. The penetration of the liquid precursor is controlled in such a way that the processed ceramic electrolyte has at least one hermetic region having relatively small microcracks and lower porosity; and at least one compliant region having relatively large microcracks and higher porosity. In certain embodiments, the liquid precursor is employed (or “used”) in the form of a solution. The solution may comprise any solvent and a soluble salt material that allows formation of the solution. The metals are present in the form of cations. The corresponding anions are inorganic compounds, for example nitrate NO³⁻, or organic compounds, for example alcoholates or acetates. If alcoholates are used, then chelate ligands, such as acetyl acetonate, may be advantageously added to decrease the hydrolysis sensitivity of the alcoholates. Examples of suitable solvents are toluene, acetone, ethanol, isopropanol, ethylene glycol, and water. Aqueous and alcohol solutions of nitrates, and organic-metallic soluble materials, such as oxalates, acetates, and citrates, may also be used. The solution desirably has suitable wettability and solubility properties to permit infiltration into the pores and microcracks. In one embodiment, the porosity was reduced from 8% of the volume to 5.8% of the volume, an approximate decrease in crack volume of 25%.

When the electrolyte comprises an oxide of a metal Me, where Me is. Zr, Ce, Y, Al or Ca, the precursor solution may comprise a nitrate Me(No₃)ₓ, where x=2 for Ca, and x=3 for Zr, Ce, Y, Al, Co, Mn, Mg, Ca, Sr, Y, Zr, Al, Ti. Alternatively (or in addition), the precursor solution may comprise a lanthanide, such as Ce, Eu or Gd. The metal nitrates are generally available as crystalline hydrates, for example Ce(No₃)₃.6H₂O, which are easily soluble in water. Metal nitrates decompose into the corresponding oxides at elevated temperatures, while simultaneously forming gaseous NO₂. The conversion temperature at which oxide formation results is known for many of the nitrates and, accordingly, the processing conditions are chosen.

Typically, the oxidizable metal ion may be thermally converted into a metal oxide. After infiltrating a desired number of microcracks, the solvent is evaporated as the temperature increases under heat input, and the metal changes into the metal oxide at an elevated temperature, thereby closing the infiltrated microcracks. As used herein, “closing a selected number of microcracks” encompasses reducing the dimension of the cracks by filling the cracks or by closing the surfaces of the cracks. In the heat treatment, the heat input can be carried out in a thermal oven, in a microwave oven, with a heat radiator, or with a flame. A multiple repetition of the infiltration and heating processes may be carried out in order to achieve any specific microstructure and gas permeability values.

The embodiments of the present invention are fundamentally different from those conventionally known in the art. There have been reports of infiltrating highly porous ceramic layers with metal ions, and heat treating them in order to densify the ceramic layer. In such cases, the initial ceramic layers are highly porous (porosity>10%) and have micron-sized microcracks that result in relatively higher gas permeability (higher than 3.5×10⁻¹⁰ cm²Pa⁻¹ sec⁻¹). As a result, it is difficult to control the infiltration of metal ions to confine them preferentially in certain regions. In such cases, the processed ceramic layer is a denser ceramic material, as compared to the initial ceramic layer. However, it is unlikely that the ceramic layer would have different microstructures at different regions of the layer, characterized by different compliance and elastic moduli. The ceramic electrolytes of the inventive embodiments are characterized by varying elastic coefficients within the same monolithic structures. The above embodiments provide simpler and versatile methods to obtain ceramic electrolytes with controlled microcrack dimensions, and hence varying elastic properties in different regions.

The following examples serve to illustrate the features and advantages offered by the present invention, and are not intended to limit the invention thereto.

### EXAMPLE 1

### Preparation of Yttria-Stabilized Zirconia (YSZ) Electrolyte Having at Least One Hermetic Region and at Least One Compliant Region

Yttrium nitrate and zirconium dinitrate oxide aqueous precursor solutions were prepared and mixed in the appropriate ratios to yield a 0.6 M solution with a 8 mol % Y₂O₃—ZrO₂(8YSZ) final composition, after nitrate decomposition. A one inch diameter porous stainless steel substrate with a 65 micron thick 8YSZ air plasma sprayed (APS) electrolyte was used as a baseline. The 8YSZ nitrate solution was painted at 3.5 mg/cm² onto the APS coating, during which the solution visibly wicked into the permeable coating. The substrate was air dried at room temperature and 70° C. for approximately 5 minutes each. The substrate was then subjected to a heat treatment to 500° C. for 0.5 hours, at a heating and cooling rate of 2° C./min, to decompose the nitrates and form oxides. The process was repeated a total of 10 times, from coating to heat treatment.

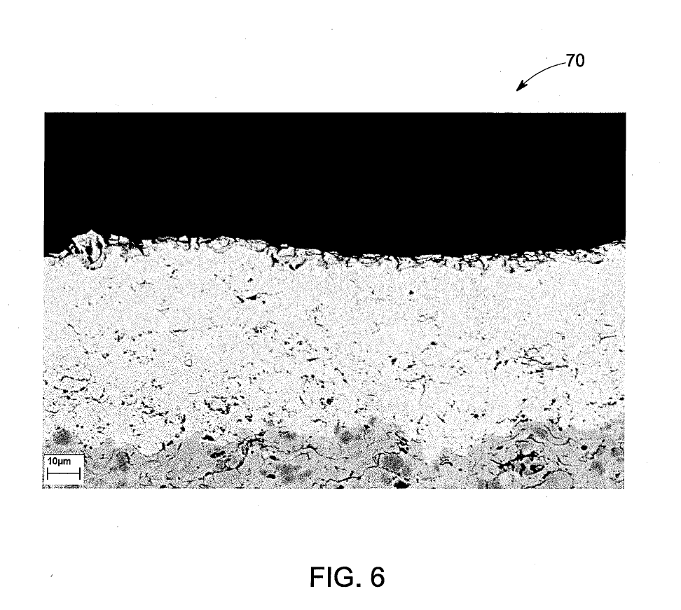

A micrograph of a typical as-deposited APS electrolyte structure is shown in FIG. 1. The micrograph shows the microcracks and pores throughout the thickness of the coating. FIG. 6. shows the microstructure of the sample after ten nitrate coatings and heat treatments. The microstructure near the top surface has smaller microcracks and lower porosity, providing a hermetic region. This microstructure results from the more-efficient closing of the microcracks (with YSZ) near the top surface of the electrolyte, using nitrate precursors. The microstructure near the bottom surface of the layer shows larger microcracks and larger porosity.

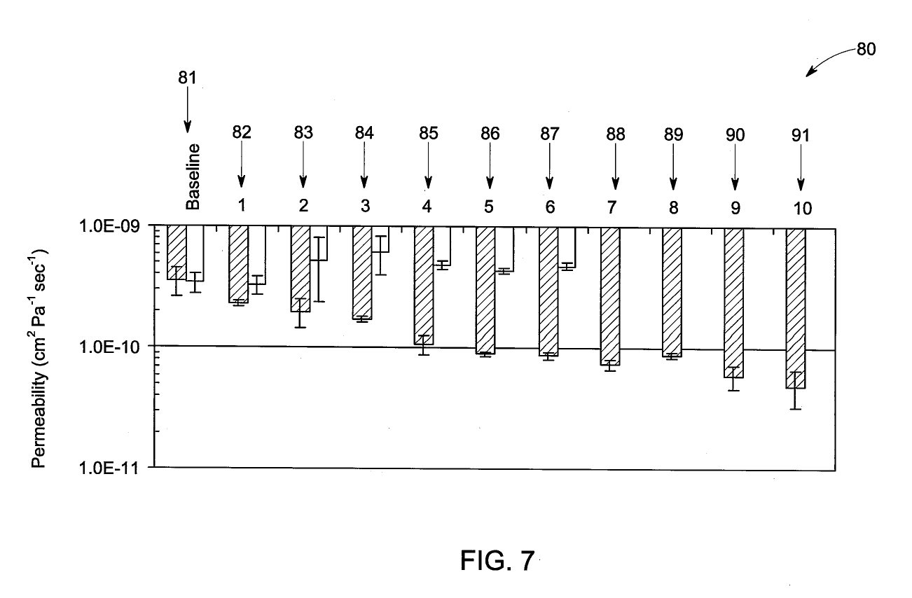

FIG. 7 shows the change in permeability after each coating and heat treatment interation, (plot 80) compared to a control which was only subjected to heat treatments, without the application of the YSZ nitrate solution. The permeability of the baseline substrate and APS coating (bar 81) was 3.53×10⁻¹⁰ cm²Pa⁻¹ sec⁻¹ (with a standard deviation of 9.53×10⁻¹⁰ cm²Pa⁻¹ sec⁻¹). Bars 82, 83, 84, 85, 86, 87, 88, 89, 90, and 91 show progressive improvement in permeability with coating and heat treatment iterations. After applying 10 coatings followed by heat treatment, the permeability was decreased, by almost an order of magnitude, to 4.94×10⁻¹¹ cm²Pa⁻¹ sec⁻¹ (with a standard deviation of 1.66×10⁻¹¹ cm²Pa⁻¹ sec⁻¹).

### EXAMPLE 2

### Yttria-Stabilized-Zirconia Nitrate Precursors Applied on a 4 Inch (10.2 cm) Cell

Yttrium nitrate and zirconium dinitrate oxide aqueous precursor solutions were prepared and mixed in the appropriate ratios to yield a 0.9 M solution with a 8 mol % Y₂O₃—ZrO₂(8YSZ) final composition after nitrate decomposition. A four inch square SOFC anode enclosure, typical of those used for electrochemical testing, with a 8YSZ air plasma sprayed (APS) electrolyte, was used as the baseline for subsequent nitrate solution infiltrations.

The 8YSZ nitrate solution was painted onto the APS coating, with a target of 2 mg/cm² loading, during which the solution visibly wicked into the permeable coating. The substrate was dried at room temperature, under vacuum, for approximately 5 minutes, and then dried at 70° C. for an additional 5 minutes in air. The substrate was then inserted into a 300° C. pre-heated furnace for 1.5 minutes to partially decompose the nitrates and impose some volume consolidation of the infiltrated material. This coating, drying and heating procedure was carried out a total of 4 times. A fifth coating and drying was completed, and the coated substrate was then heat treated to 500° C. for 0.5 hour at 2° C./min. During this heat treatment, the anode side was exposed to a 10% hydrogen balance nitrogen mixture, to prevent any oxidation of the internal enclosure metals. At the same time, the electrolyte was exposed to flowing air, to fully decompose the infiltrated nitrates, and to oxidize the 8YSZ material. Four coatings followed by a 300° C. heat treatment, and a fifth coating followed by a 500° C. heat treatment, is considered one processing cycle. The four inch substrate was exposed to four processing cycles (a total of four 500° C. heat treatments), and then tested for permeability.

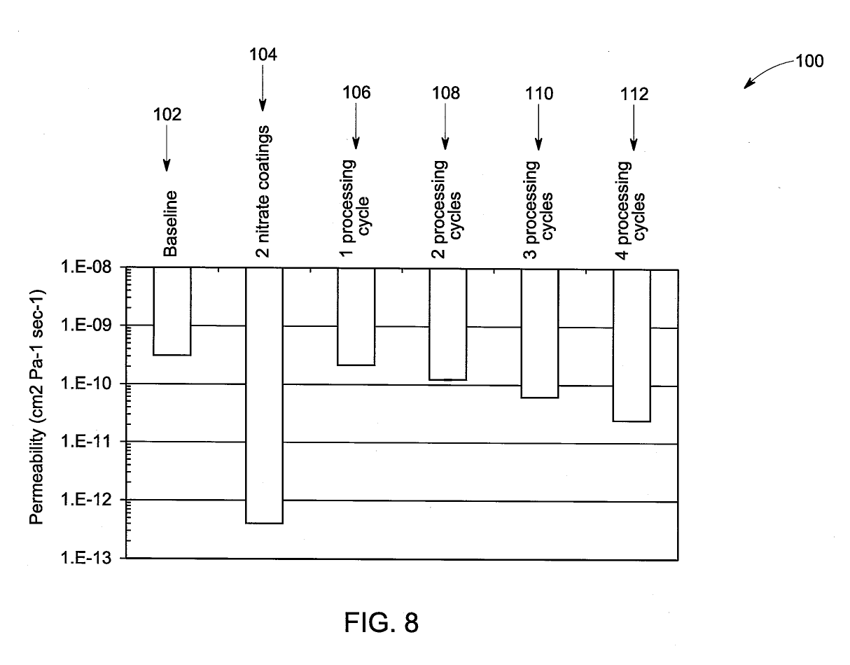

FIG. 8. shows the results of a pressure decay test with air using permeability units (plot 100). Baseline permeability (bar 102) was measured at 3.09×10⁻¹⁰ cm²Pa⁻¹ sec⁻¹. After two nitrate coatings and two 300° C. heat treatments (bar 104), the permeability was reduced by three orders of magnitude, indicating the nitrate solutions were targeting the leaks responsible for the pressure decay. After the first 500° C. heat treatment, the permeability increased to 2.15×10⁻¹⁰ cm²Pa⁻¹ sec⁻¹, which was an indication that the nitrates were not fully decomposing during the 300° C. heat treatments. However, the permeability was decreasing after each processing cycle. Bars 106, 108, 110, and 112 show progressive improvement in permeability with coating and heat treatment iterations. After four cycles, the permeability was 2.47×10⁻¹¹ cm²Pa⁻¹ sec⁻¹, more than an order of magnitude better than the baseline measurement (bar 112).

While the invention has been described with reference to exemplary embodiments, it will be understood by those skilled in the art that various changes may be made, and equivalents may be substituted for elements thereof, without departing from the scope of the invention. In addition, many modifications may be made to adapt a particular situation or material to the teachings of the invention, without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed:

1. A ceramic electrolyte having a microstructure, which comprises at least a first region comprising a plurality of microcracks having a first average microcrack length and a first average microcrack width, and a second region comprising a second average microcrack length and a second average microcrack width, wherein
(a) the first average microcrack length is different from the second average microcrack length; or
(b) the first average microcrack width is different from the second average microcrack width.

2. The ceramic electrolyte of claim 1, comprising a monolithic structure.

3. The ceramic electrolyte of claim 2, wherein the monolithic structure has a thickness in the range from about 5 micrometers to about 70 micrometers.

4. The ceramic electrolyte of claim 3, wherein the monolithic structure has a thickness in the range from about 15 micrometers to about 50 micrometers.

5. The ceramic electrolyte of claim 1, wherein the second average microcrack length is at least about 10% larger than the first average microcrack length.

6. The ceramic electrolyte of claim 5, wherein the second average microcrack length is at least about 15% larger than the first average microcrack length.

7. The ceramic electrolyte of claim 1, wherein the second average microcrack width is at least about 5% larger than the first average microcrack width.

8. The ceramic electrolyte of claim 7, wherein the second average microcrack width is at least about 10% larger than the first average microcrack width.

9. The ceramic electrolyte of claim 1, wherein the microstructure further comprises a first porosity in the first region and a second, different porosity in the second region.

10. The ceramic electrolyte of claim 9, wherein the second porosity is at least about 10% larger than the first porosity.

11. The ceramic electrolyte of claim 10, wherein the second porosity is at least about 20% larger than the first porosity.

12. The ceramic electrolyte of claim 1, wherein the first region comprises a region from a top surface of the ceramic electrolyte to about 45% of the depth of the ceramic electrolyte.

13. The ceramic electrolyte of claim 1, wherein the second region comprises a region extending from a bottom surface of the ceramic electrolyte, upwardly, to about 45% of the depth of the ceramic electrolyte.

14. The ceramic electrolyte of claim 1, wherein the ceramic electrolyte comprises a material selected from the group consisting of zirconia, ceria, hafnia, bismuth oxide, lanthanum gallate, and thoria.

15. The ceramic electrolyte of claim 14, comprising a material selected from the group consisting of yttria-stabilized zirconia, rare-earth-oxide-stabilized zirconia, scandia-stabilized zirconia, rare-earth doped ceria, alkaline-earth doped ceria, stabilized hafnia, rare-earth oxide stabilized bismuth oxide, and lanthanum strontium magnesium gallate.

16. The ceramic electrolyte of claim 14, comprising yttria-stabilized zirconia.

17. The ceramic electrolyte of claim 1, comprising thermally-sprayed yttria-stabilized zirconia.

18. A solid oxide fuel cell comprising the ceramic electrolyte of claim 1.

19. A solid oxide fuel cell comprising:
an anode,
a cathode,
and a ceramic electrolyte disposed between the anode and the cathode, wherein the ceramic electrolyte has a microstructure which comprises at least a first region comprising a plurality of microcracks having a first average microcrack length and a first average microcrack width; and a second region comprising a second average microcrack length and a second average microcrack width; wherein
(a) the first average microcrack length is different from the second average microcrack length; or
(b) the first average microcrack width is different from the second average microcrack width.

20. The solid oxide fuel cell of claim 19, wherein the ceramic electrolyte comprises a material selected from the group consisting of zirconia, ceria, hafnia, bismuth oxide, lanthanum gallate, and thoria.

21. The solid oxide fuel cell of claim 20, wherein the ceramic electrolyte comprises yttria-stabilized zirconia.

22. The solid oxide fuel cell of claim 21, wherein the ceramic electrolyte comprises a thermally sprayed yttria-stabilized zirconia.

23. The solid oxide fuel cell of claim 19, wherein the second average microcrack length is at least about 10% larger than the first average microcrack length.

24. The solid oxide fuel cell of claim 19, wherein the second average microcrack width is at least about 5% larger than the first average microcrack width.

25. The solid oxide fuel cell of claim 19, wherein the microstructure further comprises a first porosity in the first region and a second, different porosity in the second region.

26. The solid oxide fuel cell of claim 25, wherein the second porosity is at least about 30% larger than the first porosity.

27. A method of forming a ceramic electrolyte, wherein the ceramic electrolyte has at least one hermetic region and at least one compliant region, comprising:
providing a ceramic electrolyte comprising a plurality of nano-dimensional microcracks; and
closing a number of the nano-dimensional microcracks preferentially from one surface of the ceramic electrolyte, such that the ceramic electrolyte has at least one hermetic region and at least one compliant region.

28. The method of claim 27, wherein the hermetic region comprises a plurality of nano-dimensional microcracks having a first average microcrack length and a first average microcrack width, and the compliant region comprising a second average microcrack length and a second average microcrack width, wherein
(a) the first average microcrack length is different from the second average microcrack length; or
(b) the first average microcrack width is different from the second average microcrack width.

29. The method of claim 27, wherein the ceramic electrolyte comprising a plurality of nano-dimensional microcracks has a gas permeability, measured in air, of less than about 8×10⁻¹⁰ cm²Pa⁻¹ sec⁻¹.

30. The method of claim 27, wherein the ceramic electrolyte comprising a plurality of nano-dimensional microcracks has a porosity less than 10%.

31. The method of claim 27, wherein the plurality of nano-dimensional microcracks has an average microcrack length of less than about 2000 nanometers.

32. The method of claim 27, wherein the plurality of nano-dimensional microcracks have an average microcrack width of less than about 200 nanometers.

33. The method of claim 27, wherein providing the ceramic electrolyte comprises thermally spraying the ceramic electrolyte.

34. The method of claim 27, wherein closing the plurality of nano-dimensional microcracks comprises:
infiltrating the ceramic electrolyte with a liquid precursor comprising a plurality of cations, wherein the liquid precursor comprises at least one oxidizable metal ion; and
heating the ceramic electrolyte to a temperature sufficient to convert the metal ion to an oxide, thereby closing a selected number of the nano-dimensional microcracks.

35. The method of claim 27, wherein the ceramic electrolyte comprises a material selected from the group consisting of yttria-stabilized zirconia, rare-earth-oxide-stabilized zirconia, scandia-stabilized zirconia, rare-earth doped ceria, alkaline-earth doped ceria, and rare-earth oxide stabilized bismuth oxide.

36. The method of claim 35, wherein the ceramic electrolyte comprises yttria-stabilized zirconia.

37. A method of forming a ceramic electrolyte having at least one hermetic region and at least one compliant region, comprising:
providing a ceramic electrolyte comprising yttria-stabilized zirconia, which itself comprises a plurality of nano-dimensional microcracks, and which has a gas permeability, measured in air, of less than about 8×10⁻¹⁰ cm²Pa⁻¹ sec⁻¹;
infiltrating the ceramic electrolyte with a liquid precursor comprising a plurality of cations, the infiltration being carried out from one selected surface of the ceramic electrolyte, wherein the liquid precursor comprises at least one oxidizable metal ion; and
heating the ceramic electrolyte to a temperature sufficient to convert the metal ion to an oxide, thereby closing a selected number of the nano-dimensional microcracks.
